(19) United States
(12) Patent Application Publication
(10) Pub. No.: US 2012/0024104 A1
(43) Pub. Date: Feb. 2, 2012

(54) PARKING BRAKE DRIVE UNIT

(75) Inventors: Palacio Argüelles Joseba, Santurtzi (ES); Revilla Mozas Alexander, Bilbao (ES)

(73) Assignee: BATZ, S.COOP., IGORRE (Bizkaia) (ES)

(21) Appl. No.: 13/194,769

(22) Filed: Jul. 29, 2011

(30) Foreign Application Priority Data
Jul. 30, 2010 (ES) P201031191

(51) Int. Cl. B60T 7/10

(52) U.S. Cl. 74/501.6; 74/529

(57) ABSTRACT

In one implementation a parking brake drive unit for a vehicle is provided that includes a main lever assembled in a pivoting manner on a support; a pivoting catch member on the main lever that includes engagement means adapted to engage a fixed geared sector, a button assembled on the main lever and connected to a rod that is adapted to move the catch member to disengage the engagement means from the geared sector when the button is operated; and an electrically activated locking device that operates to immobilize the rod when the locking device is electrically de-activated.

### CROSS-REFERENCE TO RELATED APPLICATIONS

This application relates to and claims priority to Spanish Patent Application No. P201031191, filed Jul. 30, 2010.

### TECHNICAL FIELD

The invention relates to parking brakes for vehicles.

### BACKGROUND

The prior art contains known parking brake drive units that comprise a lever assembled in a pivoting manner on a support fixed to the chassis of the vehicle and disposed to be operated by causing its rotation in one or another direction to tighten a brake device. A catch member enables the rotation of the lever in a braking direction but prevents its rotation in an opposite direction, as a result of which the lever remains in the maximum tightening position reached. On the lever is disposed a button that may be operated manually to release the catch member and thereby loosen the tension of the brake device. Generally speaking, the catch member includes a catch lever assembled in a pivoting manner on the aforementioned main lever, and this catch lever has at least one claw adapted to engage in a geared sector fixed on the aforementioned support of the main lever. The button and the catch member are connected mechanically by means of a rod, and a spring is disposed to push the claw of the catch member against the geared sector.

European patent EP1650092 B1 discloses a parking brake drive unit of the type described above, in which the button is assembled on the main lever and connected to one end of a rod that has a second end adapted to push the catch member, which disengages the claw from the geared sector when the button is operated. The device includes a first spring or main spring similar to a conventional one to return the button to its extended position, and a second spring, or catch spring, disposed between a portion of the catch member and a portion of the rod to push one against the other and the claw against the geared sector of the support at the same time.

### SUMMARY OF THE DISCLOSURE

According to one implementation a parking brake drive unit is provided comprises a main lever assembled in a pivoting manner on a support and disposed to be operated to activate a brake device; a catch member assembled in a mobile manner on the main lever and which has at least one engagement means, preferably a claw, adapted to engage in a preferably geared sector fixed on the support; a main spring disposed to push the claw of the catch member against the geared sector; and a button assembled on the main lever and connected to a movable rod, adapted to move the catch member in a suitable direction to disengage engagement means from the geared sector when the button is operated. The parking brake drive unit further comprises a locking device that immobilises the rod when the locking device is not activated electrically.

When the parking brake drive unit is activated, the main lever is rotated in relation to the fixed support and the brake device is tightened. In this situation if the locking device is activated electrically, the rod is not immobilised and the main lever may rotate, with it returning to its rest position, as when the button is pressed it acts on the rod, which is not immobilised, and this piece, which is adapted to move the catch member, releases it, disengaging the claw from the geared sector. The brake device may thus be loosened and the unit released.

If the locking device is not activated electrically, the rod is locked, with the result that when the button is pressed it cannot move and cannot act therefore on the catch member, and the unit is locked.

According to one implementation, a parking brake drive unit for a vehicle is provided comprising: a main lever having a proximal end and a distal end, the distal end assembled in a pivoting manner on a support; a brake device coupled with the distal end of the main lever and moveable with the main lever as the main lever pivots in relation to the support; a stationary geared sector fixed to the support and disposed at or near the distal end of the main lever; a catch member assembled in a mobile manner on the main lever and which has an engagement member adapted to engage with the geared sector, the engagement member urged toward the geared sector by a spring; a first rod having a length extending between a first end and a second end, the first rod operatively coupled with the catch member and moveable between a first axial rest position and a second axial position, when in the first axial rest position the engagement member engages with the geared sector and when in the second axial position the engagement member is not engaged with the geared sector, the first end of the first rod positioned at or near the proximal end of the main lever that when acted upon causes the first rod to be moved between the first axial rest position and the second axial position, the first rod having a receptacle disposed in a position along its length; and an electrically activated locking device attached to the main lever in a fixed position relative to the first rod, the locking device comprising a member that is moveable between a first position when the locking device is electrically de-activated and a second position when the locking device is electrically activated, when in the first position the member resides in the receptacle of the first rod to lock the first rod in the first axial rest position, when in the second position the member resides outside the receptacle of the first rod to permit movement of the first rod between the first axial rest position and the second axial position.

According to another implementation, a parking brake drive unit for a vehicle is provided comprising: a main lever having a proximal end and a distal end, the distal end assembled in a pivoting manner on a support; a brake device coupled with the distal end of the main lever and moveable with the main lever as the main lever pivots in relation to the support; a stationary geared sector fixed to the support and disposed at or near the distal end of the main lever; a catch member assembled in a mobile manner on the main lever and which has an engagement member adapted to engage with the geared sector, the engagement member urged toward the geared sector by a spring; a flexible rod operatively coupled with the catch member and moveable between a first axial rest position and a second axial position, when in the first axial rest position the engagement member engages with the geared sector and when in the second axial position the engagement member is not engaged with the geared sector, a first end of the flexible rod positioned at or near the proximal end of the main lever that when acted upon causes the flexible rod to be moved between the first axial rest position and the second axial position; a rigid member coupled with the flexible rod and slideable between first and second positions on the main lever, the rigid member having a receptacle in a side thereof; and an electrically activated locking device attached to the main lever in a fixed position relative to the rigid member, the locking device comprising a member that is moveable between a first position when the locking device is electrically de-activated and a second position when the locking device is electrically activated, when in the first position the member resides in the receptacle of the rigid member to lock the flexible rod in the first axial rest position, when in the second position the member resides outside the receptacle of the rigid member to permit movement of the flexible rod between the first axial rest position and the second axial position.

According to another implementation, a parking brake drive unit for a vehicle is provided comprising: a main lever having a proximal end and a distal end, the distal end assembled in a pivoting manner on a support; a brake device coupled with the distal end of the main lever and moveable with the main lever as the main lever pivots in relation to the support; a stationary geared sector fixed to the support and disposed at or near the distal end of the main lever; a catch member assembled in a mobile manner on the main lever and which has an engagement member adapted to engage with the geared sector, the engagement member urged toward the geared sector by a spring; a first flexible rod having a first end portion and a second end portion, the first end portion positioned at or near the proximal end of the main lever; a second flexible rod having a first end portion and a second end portion, the second end portion of the second flexible rod coupled to the catch member; a rigid member coupled with the second end portion of the first flexible rod and the first end portion of the second flexible rod and slideable between first and second positions on the main lever, the rigid member having a receptacle in a side thereof, when the rigid member is in the first position the engagement member engages with the geared sector and when the rigid member is in the second position the engagement member is not engaged with the geared sector; and an electrically activated locking device attached to the main lever in a fixed position relative to the rigid member, the locking device comprising a member that is moveable between a first position when the locking device is electrically de-activated and a second position when the locking device is electrically activated, when in the first position the member resides in the receptacle of the rigid member to lock the rigid member in the first position, when in the second position the member resides outside the receptacle of the rigid member to permit movement of the rigid member between the first and second positions.

### BRIEF DESCRIPTION OF THE DRAWINGS

FIG. 1 shows a side view of an embodiment of a parking brake drive unit in a situation in which the brake is activated and locked.

FIG. 2 shows a side view of the unit of FIG. 1 in a situation in which the brake is activated and unlocked.

FIG. 3 shows a side view of the unit of FIG. 1 in a situation in which the brake is unlocked.

FIG. 4 shows a side view of another embodiment of the parking brake drive unit of the invention in a situation in which the brake is unlocked.

### DETAILED DESCRIPTION

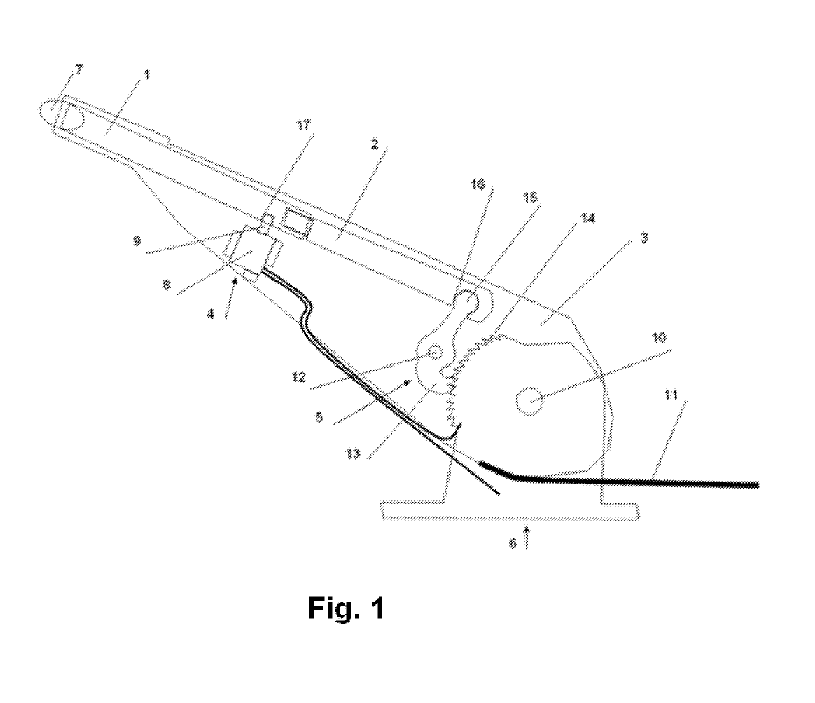

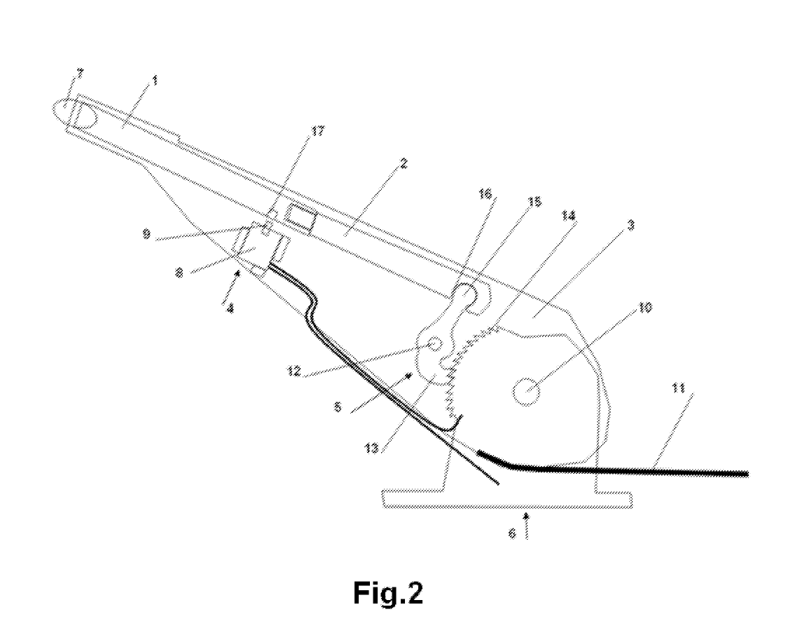

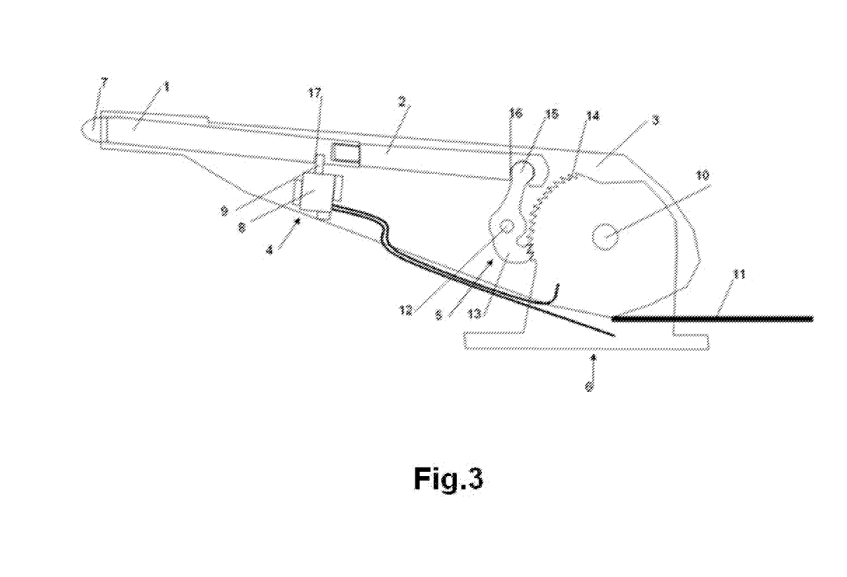

FIGS. 1 to 3 show a parking brake drive unit with locking device in accordance with an example embodiment. FIG. 1 shows a side view of the parking brake drive unit in a situation in which the brake is activated and locked. FIG. 2 shows the unit of FIG. 1 in a situation in which the brake is activated and unlocked. FIG. 3 shows the unit of FIG. 1 in a situation in which the brake is unlocked. In one implementation the parking brake drive unit comprises a main lever 3 assembled so that it may pivot in relation to an axis 10 on a support 6 fixed to the chassis of the vehicle. The main lever 3 is disposed to be operated to activate a brake device 11, such as, for example, a cable that is coupled to a brake. The tension of the device 11 increases as the free end of the main lever 3 is raised.

On the main lever 3 is assembled a catch member 5, which, in the example shown, has the form of a lever assembled to pivot in relation to an axis 12, but which may adopt other configurations, such as that of an appropriately guided sliding member. In this example, the aforementioned catch member 5 has a first arm on a first side of the axis 12, on which there is an engagement member or means, such as a claw 13 in this case, while on a second arm on a second side of the axis 12 of the catch member 5, is found a support member 15 that is connected with or otherwise engageable with a second end 16 of an auxiliary rod 2.

In this example embodiment, on the free end of the main lever 3 there is a button 7 that may be assembled in a sliding manner and connected to a first end of a movable rod 1, although they may be components made up of a single piece. In one implementation rod 1 has a receptacle 17 situated to receive a moveable shaft 9 of an electrically actuated locking device 4. In one implementation rod 1 is connected in a sliding and coaxial manner at its second end to a first end of the auxiliary rod 2. As explained above, the second end 16 of the auxiliary rod 2 is adapted to engage with the support member 15 of the catch member 5 and push it in a suitable direction to separate the aforementioned engagement member 13 from the geared sector 14 when the button 7 is depressed. To return the button 7 to an extended position in relation to the main lever 3, after having been depressed, there is a spring (not shown in the figures) that acts on the auxiliary rod 2 and, through its sliding connection with the rod 1, acts on the button 7 to urge it to its original rest position. In addition, as the spring acts on the auxiliary rod 2, its second end 16 acts on the support member 15 of the catch member 5, which pushes the engagement member 13 against the geared sector 14.

On the main lever 3 is assembled a locking device 4 facing the rod 1, which in the example shown comprises an electric actuation system 8 (e.g., an electromagnet) and a moveable shaft 9. When the electric actuation system 8 receives an electrical signal, it is activated and the moving shaft 9 is withdrawn in a direction away from and out of the receptacle 17 of rod 1, and when it does not receive an electrical signal it is deactivated and the moveable shaft 9 is extended and is housed in the receptacle 17 of rod 1.

To activate the parking brake drive unit from the rest position, the handle of the main lever 3 is seized and moves upwards, it being rotated in relation to the fixed support 6 and the brake device 11 tightening. This operation may be performed whether an electrical signal reaches locking device 4 or not. If the signal arrives, the moveable shaft 9 is withdrawn, and when the signal does not arrive the moving shaft 9 is extended and housed in the receptacle 17 of rod 1, although during the movement of the main lever 3 there is nothing to prevent the pivoting of the catch member 5 on its axis 12, pulling the claw 13 on the geared sector 14.

To deactivate the parking brake drive unit, the handle of the main lever 3 is seized and the button 7 pressed in order to release the catch member 5. In this situation, if the locking device 4 is activated electrically, the moveable shaft 9 is withdrawn from the receptacle 17 of rod 1 and the main lever 3 may rotate, returning it to its rest position, as when the button 7 is pressed it acts on the rod 1, which is not locked, and this in turn permits rod 1 to move axially to act on the auxiliary rod 2, which is connected in a sliding manner to it. The auxiliary rod 2 thus acts on the catch member 5 and disengages the engagement member 13 from the geared sector 14. The brake device may thus be loosened and the unit released.

If the locking device 4 is not activated electrically, the moveable shaft 9 is extended and housed transversally in the receptacle 17 of rod 1. In this situation the rod 1 is locked, with the result that when the button 7 is pressed, the rod 1 cannot move axially and cannot therefore act on the auxiliary rod 2, as a consequence of which it does not allow the catch member 5 to be acted on and the engagement member 13 remains engaged in the geared sector 14. The unit is thus locked and its improper use is prevented. However, the main lever 3 may be rotated further upwards in relation to the rest position, and may therefore tighten the brake device 11 more, as the auxiliary rod 2, as it is sliding and coaxial to the rod 1, enables the catch element 5 to pivot in relation to its axis 12 and the engagement member 13 may be moved on the geared sector 14.

In other alternative example embodiments, the locking device 4 comprises a piezoelectric sensor, an electric motor or similar member, which when activated electrically converts the electrical signal into a mechanical movement, thereby moving the moving shaft 9.

In the example embodiment described in FIGS. 1 to 3, the rods 1 and 2 are connected in a sliding and coaxial manner with the result that rod 1 is disposed with an internal bore on its second end and the auxiliary rod 2 is disposed with a stud on its first end that is housed in the internal bore of rod 1. In another embodiment, the second end of rod 1 comprises a stud while the first end of the auxiliary rod 2 comprises an internal bore with the stud of rod 1 being disposed within the internal bore the auxiliary rod 2. Other arrangements are also possible.

In this embodiment the rods are preferably rigid and may be made of metal, plastic, or any other suitable material or combination of materials.

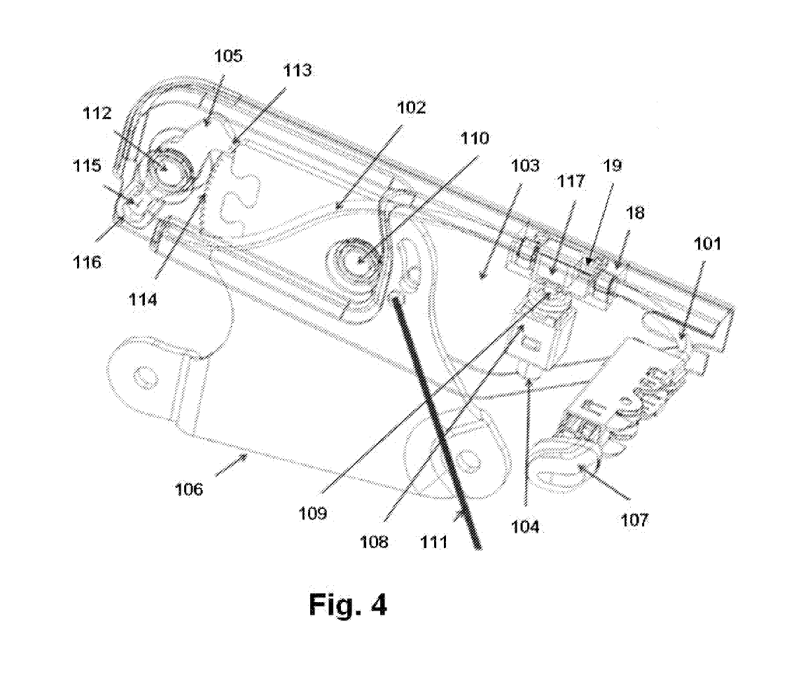

FIG. 4 shows a parking brake drive unit with locking device in accordance with another example embodiment. In the example embodiment of FIG. 4, on the free end of the main lever 103 there is a button 107 connected to a movement inversion mechanism and connected to a first end of a flexible rod 101 (cable, rope or similar). A second end of rod 101 is housed in a connection device 18, which internally comprises a rigid member 19 that is connected with or otherwise engageable with the second end of rod 101. The rigid member 19 slides inside the connection device 18. The rigid member 19 comprises a receptacle 117 for receiving a moveable shaft 109 of a locking device 104, and is connected at its other end to a first end of a flexible auxiliary rod 102. A second end 116 of the auxiliary rod 102 is adapted to directly or indirectly engage with the support member 115 of the catch member 105, and drive it in a suitable direction to separate the engagement member 113 from the geared sector 114 when the button 107 is pressed. When operated, and through the movement inversion mechanism, it causes a driving of the rod 101, which is transmitted through the connection device 18 to the auxiliary rod 102. At the same time auxiliary rod 102 transmits this movement to the catch member 105 in a suitable direction to separate the engagement member 113 from the geared sector 114.

On the main lever 103 is assembled a locking device 104 facing the connection device 18. When the electric actuation system 108 receives an electrical signal, it is activated and the moveable shaft 109 is withdrawn in a direction away from and out of receptacle 117 of rigid member 19 within the connection device 18, and when it does not receive an electrical signal it is deactivated and the moveable shaft 109 is extended to reside in the receptacle 117 of the rigid member 19, which slides inside the connection device 18.

This embodiment of the parking brake drive unit is activated and deactivated in a manner similar to the embodiment of FIGS. 1-3. When the parking brake drive unit is activated and the locking device 104 is not activated electrically, the moveable shaft 109 is extended and housed in the receptacle 117 of the rigid member 19, which slides inside the connection device 18. In this situation the rod 101 is locked with the result that when the button 107 is pressed, the rod 101 cannot be moved and cannot therefore act on the auxiliary rod 102 as it is connected to the same rigid member 19, with the result that it does not allow the catch member 105 to be acted on and the engagement member 113 remains engaged in the geared sector 114. The unit is thus locked and its improper use is prevented. However, the main lever 103 may rotate further upwards in relation to the rest position and therefore tighten the brake device 111 more, as the auxiliary rod 102, as it is flexible, enables the catch member 105 to pivot in relation to its axis 112 and the engagement member 113 may be moved on the geared sector 114.

In an alternative implementation, a single flexible rod that extends through or across the rigid member 19 is used in lieu of the use of two rods (rod 101 and auxiliary rod 102). In such an implementation the single flexible rod is fixed to and traverses the rigid member 19 with a first end portion of the single flexible rod being positioned at or near a proximal end of the main lever and a second end portion of the single flexible rod being coupled with the support member 115 of catch member 105.

In any of the example embodiments, the incorporation of the locking device 4, 104 ensures that the parking brake drive unit is a system that remains secure against improper use when the parking brake unit is accessible, for example in an open vehicle with no windows or no top. Advantageously, the number of new components in relation to a standard brake unit is restricted to a locking device 4, 104 comprising an electric actuation system 8, 108, a moveable shaft 9, 109, an auxiliary rod 2, 102, a device for connecting the flexible rods 18 for the embodiment of FIG. 4 and the electrical cables that enable the necessary electrical signal to be conducted. These are simple and inexpensive components and furthermore the electric actuation system 8, 108 only acts when the electrical signal reaches it, and this is only required at the point the main lever 3 is deactivated. Furthermore, the moveable shaft 9, 109 may move only in an axial direction (although not required) in relation to the electric actuation system 8, as a result of which this may be a simple system.

What is claimed is:

1. A parking brake drive unit for a vehicle comprising:
a main lever having a proximal end and a distal end, the distal end assembled in a pivoting manner on a support,
a brake device coupled with the distal end of the main lever and moveable with the main lever as the main lever pivots in relation to the support,
a stationary geared sector fixed to the support and disposed at or near the distal end of the main lever,
a catch member assembled in a mobile manner on the main lever and which has an engagement member adapted to engage with the geared sector, the engagement member urged toward the geared sector by a spring,
a first rod having a length extending between a first end and a second end, the first rod operatively coupled with the catch member and moveable between a first axial rest position and a second axial position, when in the first axial rest position the engagement member engages with the geared sector and when in the second axial position the engagement member is not engaged with the geared sector, the first end of the first rod positioned at or near the proximal end of the main lever that when acted upon causes the first rod to be moved between the first axial rest position and the second axial position, the first rod having a receptacle disposed in a position along its length; and
an electrically activated locking device attached to the main lever in a fixed position relative to the first rod, the locking device comprising a member that is moveable between a first position when the locking device is electrically de-activated and a second position when the locking device is electrically activated, when in the first position the member resides in the receptacle of the first rod to lock the first rod in the first axial rest position, when in the second position the member resides outside the receptacle of the first rod to permit movement of the first rod between the first axial rest position and the second axial position.

2. A parking brake drive unit according to claim 1, further comprising a second rod having a first end and a second end, the first end of the second rod being coupled with the second end of the first rod, the second end of the second rod being coupled to the catch member, the first end of the second rod being slideable within the second end of the first rod.

3. A parking brake drive unit according to claim 1, further comprising a second rod having a first end and a second end, the first end of the second rod being coupled with the second end of the first rod, the second end of the second rod being coupled to the catch member, the second end of the first rod being slideable within the first end of the second rod.

4. A parking brake drive unit according to claim 2, wherein the first and second rods are rigid.

5. A parking brake drive unit according to claim 3, wherein the first and second rods are rigid.

6. A parking brake drive unit according to claim 2, wherein the first and second rods are coaxial.

7. A parking brake drive unit according to claim 3, wherein the first and second rods are coaxial.

8. A parking brake drive unit according to claim 1, wherein the brake device is a cable.

9. A parking brake drive unit for a vehicle comprising:
a main lever having a proximal end and a distal end, the distal end assembled in a pivoting manner on a support,
a brake device coupled with the distal end of the main lever and moveable with the main lever as the main lever pivots in relation to the support,
a stationary geared sector fixed to the support and disposed at or near the distal end of the main lever,
a catch member assembled in a mobile manner on the main lever and which has an engagement member adapted to engage with the geared sector, the engagement member urged toward the geared sector by a spring,
a flexible rod operatively coupled with the catch member and moveable between a first axial rest position and a second axial position, when in the first axial rest position the engagement member engages with the geared sector and when in the second axial position the engagement member is not engaged with the geared sector, a first end of the flexible rod positioned at or near the proximal end of the main lever that when acted upon causes the flexible rod to be moved between the first axial rest position and the second axial position,
a rigid member coupled with the flexible rod and slideable between first and second positions on the main lever, the rigid member having a receptacle in a side thereof; and
an electrically activated locking device attached to the main lever in a fixed position relative to the rigid member, the locking device comprising a member that is moveable between a first position when the locking device is electrically de-activated and a second position when the locking device is electrically activated, when in the first position the member resides in the receptacle of the rigid member to lock the flexible rod in the first axial rest position, when in the second position the member resides outside the receptacle of the rigid member to permit movement of the flexible rod between the first axial rest position and the second axial position.

10. A parking brake drive unit according to claim 9, wherein the rigid member is slideable between the first and second positions within a housing or frame fixed to the main lever.

11. A parking brake drive unit according to claim 9, wherein the rigid member is slideable between the first and second positions on a rail fixed to the main lever.

12. A parking brake unit according to claim 9, wherein the brake device is a cable.

13. A parking brake drive unit for a vehicle comprising:
a main lever having a proximal end and a distal end, the distal end assembled in a pivoting manner on a support,
a brake device coupled with the distal end of the main lever and moveable with the main lever as the main lever pivots in relation to the support,
a stationary geared sector fixed to the support and disposed at or near the distal end of the main lever,
a catch member assembled in a mobile manner on the main lever and which has an engagement member adapted to engage with the geared sector, the engagement member urged toward the geared sector by a spring,
a first flexible rod having a first end portion and a second end portion, the first end portion positioned at or near the proximal end of the main lever,
a second flexible rod having a first end portion and a second end portion, the second end portion of the second flexible rod coupled to the catch member,
a rigid member coupled with the second end portion of the first flexible rod and the first end portion of the second flexible rod and slideable between first and second positions on the main lever, the rigid member having a receptacle in a side thereof, when the rigid member is in the first position the engagement member engages with the geared sector and when the rigid member is in the second position the engagement member is not engaged with the geared sector; and
an electrically activated locking device attached to the main lever in a fixed position relative to the rigid member, the locking device comprising a member that is moveable between a first position when the locking device is electrically de-activated and a second position when the locking device is electrically activated, when in the first position the member resides in the receptacle of the rigid member to lock the rigid member in the first position, when in the second position the member resides outside the receptacle of the rigid member to permit movement of the rigid member between the first and second positions.

14. A parking brake drive unit according to claim 13, wherein the rigid member is slideable between the first and second positions within a housing or frame fixed to the main lever.

15. A parking brake drive unit according to claim 13, wherein the rigid member is slideable between the first and second positions on a rail fixed to the main lever.

16. A parking brake drive unit according to claim 13, wherein the brake device is a cable.
